(19) United States
(12) Patent Application Publication
(10) Pub. No.: US 2008/0308000 A1
(43) Pub. Date: Dec. 18, 2008

(54) EDUCTION PIPE GUIDE

(76) Inventor: Charles Pelton, Ballwin, MO (US)

Correspondence Address: Patrick W. Rasche;Armstrong Teasdale LLP, Suite 2600, One Metropolitan Square, St. Louis, MO, 63102, US

(21) Appl. No.: 11/762,465

(22) Filed: Jun. 13, 2007

(51) Int. Cl. B61D 5/00; B23P 19/04; F16L 3/00

(52) U.S. Cl. 105/358; 248/674; 29/237

(57) ABSTRACT

In one embodiment a railway tank car is described. The railway tank car includes a tank having a tank shell, the tank shell having an interior surface and an exterior surface. The railway tank car also includes an eduction pipe extending within an interior of said tank. The railway tank car also includes an eduction pipe guide affixed to the tank shell. The eduction pipe guide includes a guide member maintained at a predetermined distance from a lower portion of the tank shell interior surface. The eduction pipe guide configured such that at least a portion of the eduction pipe extends through the guide member.

### BACKGROUND OF THE INVENTION

This invention relates generally to railway tank cars and more specifically to eduction of lading held within a railway tank car. Railway tank cars are used to transport lading, which may include liquids. A railway tank car designed to transport liquids may include a protective liner, for example a rubber liner, to prevent corrosion of metal surfaces. Railway tank cars may transport caustic liquids. These liquids can damage metal components of a tank car if those components are not protected.

Railway tank cars may be configured for top and/or bottom loading and unloading. An eduction pipe is used to facilitate top loading and unloading. A first end of the eduction pipe is accessible from an exterior of the tank car for attachment to loading or unloading equipment. A second end of the eduction pipe is positioned near the bottom of the tank car to facilitate loading or unloading.

A sump may be located at a bottom portion of a railway tank car to aid unloading. The eduction pipe may be positioned near the sump. However, since the eduction pipe can move both vertically and horizontally during transport, there are restrictions as to where the second end of the eduction pipe can be positioned. Contact between the eduction pipe and a tank car protective lining may cause damage to the protective lining, which may lead to corrosion of metal components. Furthermore, regulations passed by the Association of American Railroads must be considered when using an eduction pipe in the manner described above.

### BRIEF DESCRIPTION OF THE INVENTION

In one embodiment a railway tank car is provided. The railway tank car includes a tank having a tank shell, the tank shell having an interior surface and an exterior surface. The railway tank car also includes an eduction pipe extending within an interior of the tank. The railway tank car further includes an eduction pipe guide affixed to the tank shell. The eduction pipe guide includes a guide member maintained at a predetermined distance from a lower portion of the tank shell interior surface. The eduction pipe guide is configured such that at least a portion of the eduction pipe extends through the guide member.

In another embodiment an eduction pipe guide for use in a railway tank car is provided. The railway tank car has a tank shell and the tank shell has an interior surface and an exterior surface. The eduction pipe guide includes at least two guide supports configured to attach to and extend from said tank shell, and a guide member configured to extend between the at least two guide supports. The guide member includes an opening configured so that at least a portion of an eduction pipe can extend therethrough.

In yet another embodiment a method of assembling an eduction pipe guide within a railway tank car is provided. The railway tank car has a tank shell. The method includes reinforcing a lower portion of the tank shell, attaching at least two guide supports to the reinforced surfaces, coating an interior of the tank shell and the at least two guide supports with a protective lining configured to prevent corrosion, and fastening a guide member to the at least two guide supports. The guide member has an opening configured so that at least a portion of an eduction pipe can extend therethrough.

In yet another embodiment, a method for securing an eduction pipe within a railway tank car is provided. The railway tank car has a tank shell and a sump at a lower portion of the shell. The method includes providing an eduction pipe guide that includes an opening, affixing the eduction pipe guide to the tank shell such that the opening within the eduction pipe guide is positioned a distance from, and at least partially aligned with, the sump of the railway tank car, and inserting at least a portion of the eduction pipe through the opening.

### BRIEF DESCRIPTION OF THE DRAWINGS

FIG. 1 is a partial cross-sectional view of a railway tank car including an eduction pipe and an exemplary embodiment of an eduction pipe guide.

FIG. 2a is a magnified view of a portion of FIG. 1.

FIG. 2b is an alternative embodiment of FIG. 2a.

FIG. 3 is a top plan schematic diagram of the eduction pipe guide of FIGS. 1, 2a, and 2b.

FIG. 4 is a top plan schematic diagram of an exemplary embodiment of a guide support of FIGS. 1, 2a, and 2b.

FIG. 5 is a side plan schematic diagram of the guide support of FIG. 4.

FIG. 6 is a front plan schematic diagram of the guide support of FIGS. 4 and 5.

FIG. 7 is a top plan schematic diagram of an exemplary embodiment of a shim of FIGS. 1 and 2a.

FIG. 8 is a side plan schematic diagram of the shim of FIG. 7.

FIG. 9 is a front plan schematic diagram of the shim of FIGS. 7 and 8.

FIG. 10 is a top plan schematic of an exemplary embodiment of a guide member of FIGS. 1, 2a, and 2b.

FIG. 11 is a side plan schematic of the guide member of FIG. 10.

FIG. 12 is a top plan schematic of an exemplary embodiment of a countersunk pad of FIGS. 1, 2a, and 2b.

FIG. 13 is a side plan schematic of the countersunk pad of FIG. 12.

FIG. 14 is a front plan schematic of the countersunk pad of FIGS. 12 and 13.

FIG. 15 is a flow chart of a method of assembling an eduction pipe guide within a railway tank car.

### DETAILED DESCRIPTION OF THE INVENTION

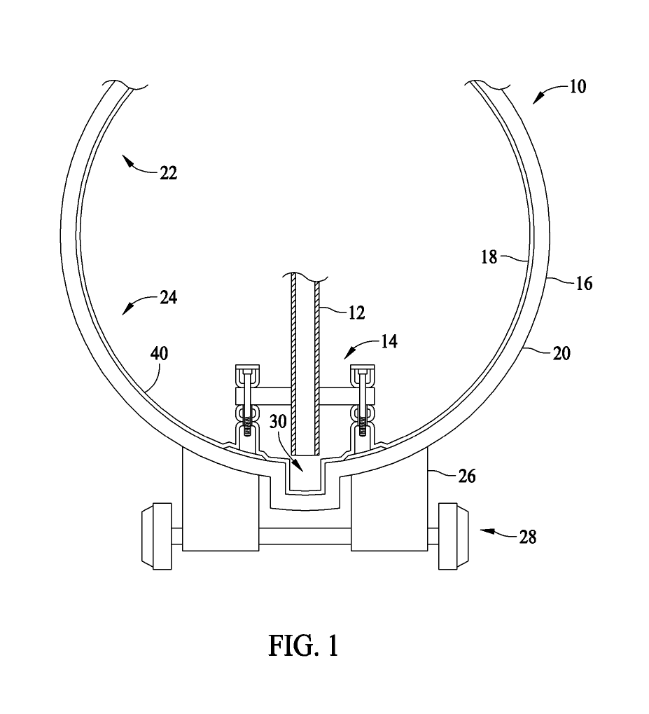

FIG. 1 is a partial cross-sectional view of a railway tank car 10 including an eduction pipe 12 and an exemplary embodiment of an eduction pipe guide 14. Tank car 10 includes a tank shell 16 having an interior surface 18 and an exterior surface 20. Tank car 10 also has an upper portion 22 and a lower portion 24, the lower portion 24 is located closer to the ground than upper portion 22 during normal use of tank car 10.

Lower portion 24 of tank car 10 rests on at least one truck assembly 26. It is known in the art that the truck assembly 26 allows tank car 10 to travel over a network of rails.

In the embodiment of FIG. 1, tank car 10 includes a sump 30. Sump 30 is a reservoir formed along lower portion 24 of tank shell 16. Sump 30 facilitates complete drainage of tank car 10 when siphoning liquids from the tank. Specifically, sump 30 permits positioning an end of eduction pipe 12 so that an end of eduction pipe 12 is near, at, or below the lower interior surface line of the tank car, while still maintaining an end of eduction pipe 12 at a clearance distance from tank shell 16.

In the embodiment of FIG. 1, tank car 10 also includes a protective lining 40. In one exemplary embodiment, lining 40 is a rubber layer coating interior surface 18 of tank shell 16. However, lining 40 may include any material able to prevent corrosion of metal that can be sprayed-on, painted-on, or adhesively attached to interior surface 18. Lining 40 also coats interior surface 18 of sump 30.

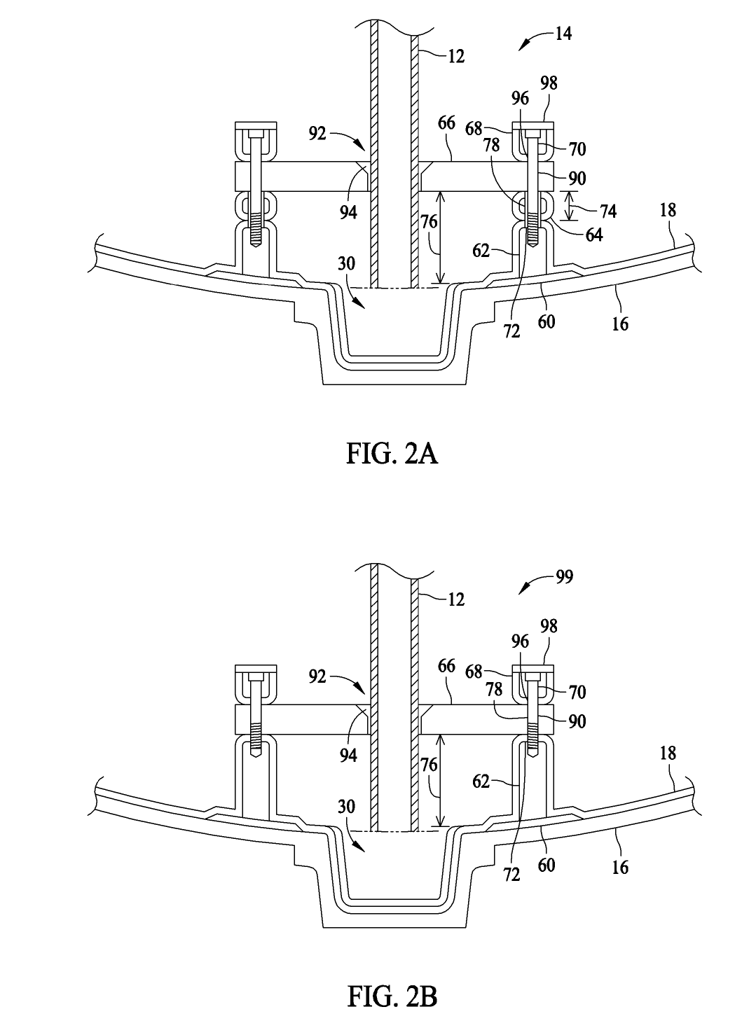

FIG. 2a is a magnified view of a portion of FIG. 1. In the embodiment of FIGS. 1 and 2a, eduction pipe guide 14 includes at least one reinforcement pad 60, at least one guide support 62, at least one shim 64, a guide member 66, at least one countersunk pad 68, and at least one fastener 70. In an exemplary embodiment, at least one reinforcement pad 60, at least one guide support 62, at least one shim 64, and at least one countersunk pad 68 are composed of metal and coated with a protective lining, for example, a rubber lining. The protective lining provides a sealing surface over the exterior of the components, which in use, are in contact with the contents of tank car 10. The protective lining prevents corrosion and/or deterioration of the metal.

Eduction pipe guide 14 includes at least one reinforcement pad 60 attached to tank shell 16. In an exemplary embodiment, at least one reinforcement pad 60 is welded to interior surface 18 of tank shell 16. However, any method of attaching reinforcement pad 60 to tank car 10 can be used. In the embodiment of FIG. 2a, eduction pipe guide 14 includes two reinforcement pads 60, one positioned on each side of sump 30.

Eduction pipe guide 14 maintains eduction pipe 12 at a predetermined position. While maintaining that position, eduction pipe guide 14 can impart forces on tank shell 16. The at least one reinforcement pad 60 strengthens tank shell 16 so that these forces do not damage tank shell 16.

The at least one reinforcement pad 60 also provides a surface to which the at least one guide support 62 is attached. The at least one guide support 62 is positioned above, and attached to, the at least one reinforcement pad 60. In an exemplary embodiment, guide support 62 is welded to reinforcement pad 60. However, any method of attaching guide support 62 to reinforcement pad 60 can be used.

Guide support 62 includes at least one securing mechanism, for example, a tapped opening 72, which is configured to accept and secure fastener 70. In an exemplary embodiment, fastener 70 includes threads configured to engage tapped opening 72. In the embodiment of FIG. 2a, eduction pipe guide 14 includes two guide supports 62, one positioned on each side of sump 30. However, any number of guide supports 62 can be included so long as at least one guide support 62 is positioned on each side of sump 30.

In the embodiment of FIG. 2a, at least one shim 64 is positioned above guide support 62 and guide member 66 is positioned above the at least one shim 64. In an exemplary embodiment, shim 64 is composed of metal, coated before assembly with a protective lining, for example a rubber lining. In another exemplary embodiment, shim 64 is composed of plastic, or any other material able to withstand contact with corrosive lading that may be transported within tank car 10. A width 74 of shim 64 determines a distance 76 at which guide member 66 is secured. Width 74 can be varied in order to position guide member 66 at a desired distance 76 from tank shell 16. Shim 64 also absorbs compression forces imparted by guide member 66. Compression forces are created due to the motion of tank car 10 and contact between guide member 66 and eduction pipe 12. Shim 64 includes at least one opening 78 configured to accept fastener 70 therethrough.

In an exemplary embodiment, guide member 66 is a flat sheet of material that extends between a plurality of guide supports 62. Guide member 66 includes at least one fastener opening 90 configured to accept fastener 70 therethrough. Guide member 66 also includes an eduction pipe opening 92 configured to allow at least a portion of eduction pipe 12 to pass through guide member 66. In an exemplary embodiment, guide member 66 includes a bevel 94. Bevel 94 aids insertion of the eduction pipe into eduction pipe opening 92.

At least one countersunk pad 68 is positioned above guide member 66. Countersunk pad 68 includes at least one opening 96 that is aligned with at least one fastener opening 90, at least one opening 78, and at least one tapped opening 72. Fastener 70 is placed through opening 96, fastener opening 90, opening 78, and held in place within tapped opening 72. In an exemplary embodiment, fastener 70 is a threaded bolt, for example, a capscrew. In another exemplary embodiment, fastener 70 is secured by welding or the use of a thread-lock material once positioned within tapped opening 72. Fastener 70, when seated within tapped opening 72, secures eduction pipe guide 14 to tank shell 16.

The at least one countersunk pad 68 also includes a cover 98. In an exemplary embodiment, cover 98 is formed from a metal that is coated with a protective lining. In another exemplary embodiment, the outer surface of countersunk pad 68 is coated with a protective lining after eduction pipe guide 14 is assembled.

FIG. 2b is an alternative embodiment of FIG. 2a. FIG. 2b is a partial cross-sectional view of an eduction pipe guide 99. Like reference characters of FIGS. 2a and 2b are used in FIGS. 2a and 2b to designate common features. In the exemplary embodiment of FIG. 2b, guide member 66 is positioned directly above guide support 62, and guide member 66 adjoins guide support 62. Eduction pipe guide 99 does not include at least one shim 64 (see FIG. 2a). In an exemplary embodiment, guide member 66 is composed of a high density polyethylene, however, any suitable material may be used so long as the material will not corrode and/or degrade when in contact with the contents of tank car 10.

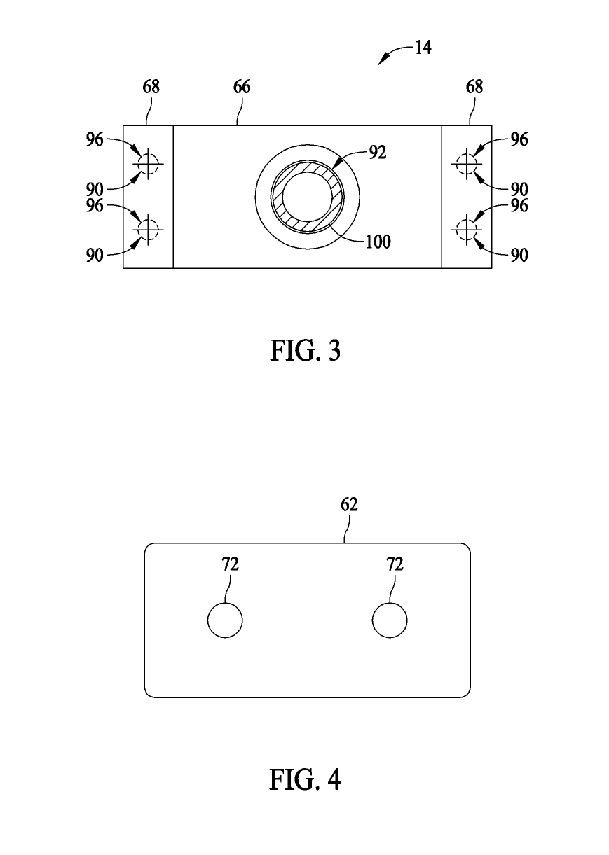

FIG. 3 is a top plan schematic diagram of eduction pipe guide 14. In the embodiment of FIG. 3, two countersunk pads 68 are positioned above guide member 66 such that each opening 96 is aligned with a fastener opening 90. Eduction pipe 12 is positioned within eduction pipe opening 92. Eduction pipe opening 92 is sized to provide a tolerance 100 between eduction pipe 12 and eduction pipe opening 92. Tolerance 100 permits eduction pipe 12 to be inserted through eduction pipe opening 92 without damaging eduction pipe 12 or guide member 66. Tolerance 100 also permits a relative vertical movement between eduction pipe 12 and guide member 66. Tolerance 100 also permits a relative horizontal movement between eduction pipe 12 and guide member 66, however, tolerance 100 is low enough to prevent eduction pipe 12 from contacting sump 30, tank shell 16, or lining 40. Such movements are typical while tank car 10 is in motion. Tolerance 100 may prevent buckling of eduction pipe 12 that may occur if eduction pipe 12 is not given any freedom to move.

Height 76 is chosen to ensure that vertical movement of eduction pipe 12 relative to guide member 66 does not cause eduction pipe 12 to be removed from guide member 66. In an exemplary embodiment, eduction pipe 12 moves a maximum of three inches, vertically upward or vertically downward, relative to guide member 66 while tank car 10 is transporting lading. In this embodiment, guide member 66 is positioned at least six inches above a lower portion of sump 30, and eduction pipe 12 is positioned at least three inches above the lower portion of sump 30.

Choosing the starting position of eduction pipe 12 and the position of guide member 66 based on a maximum relative travel of eduction pipe 12 with respect to guide member 66 ensures that vertical movement of eduction pipe 12 relative to guide member 66 does not cause eduction pipe 12 to be removed from guide member 66 until a user purposefully removes eduction pipe 12 from guide member 66. Choosing the starting position of eduction pipe 12 also ensures that vertical travel of eduction pipe 12 relative to guide member 66 will not cause eduction pipe 12 to contact lining 40.

Eduction pipe 12 contacts eduction pipe guide 14 at the edges of eduction pipe opening 92. If guide member 66 was coated with a protective lining, the relative motion between eduction pipe 12 and guide member 66 could damage the protective lining. As stated above, in one embodiment, guide member 66 is composed of a high density polyethylene, which does not require a protective lining to prevent corrosion. Since guide member 66 does not require a protective lining to prevent corrosion, eduction pipe 12 does not contact a protective lining, and the relative motion will not lead to damage or a risk of corrosion.

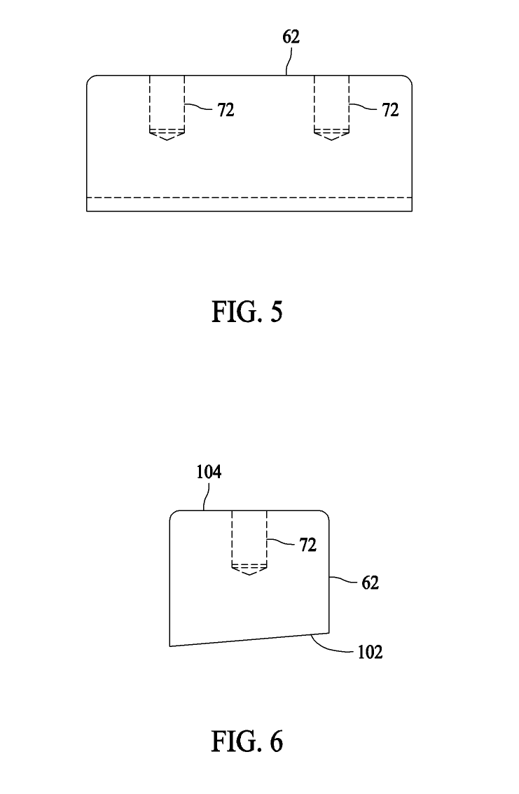

FIG. 4 is a top plan schematic diagram of an exemplary embodiment of guide support 62. FIG. 5 is a side plan schematic diagram of an exemplary embodiment of guide support 62. FIG. 6 is a front plan schematic diagram of an exemplary embodiment of guide support 62.

Guide support 62 (as shown in FIGS. 4-6) includes two tapped openings 72, however, guide support 62 may include any number of tapped openings 72. Guide support 62 also includes an angled bottom surface 102 configured for attachment to reinforcement pad 60. Angled surface 102 is configured such that when guide support 62 is attached to reinforcement pad 60, top surface 104 provides a level surface, with respect to a corresponding guide support 62, with which guide member 66 is positioned.

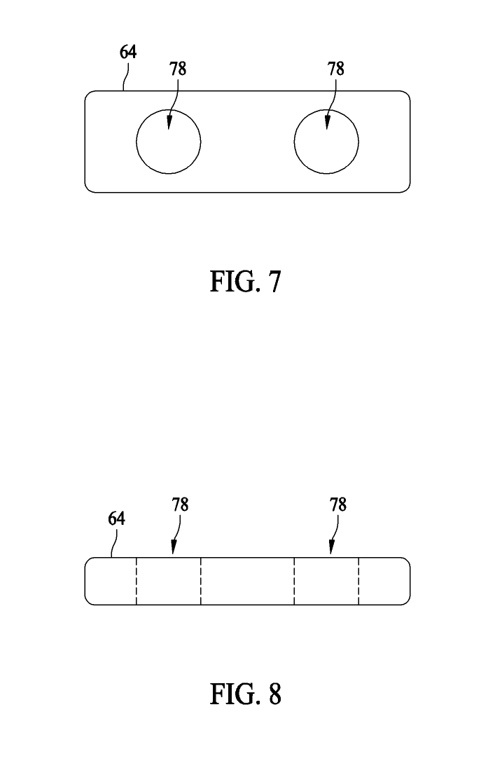

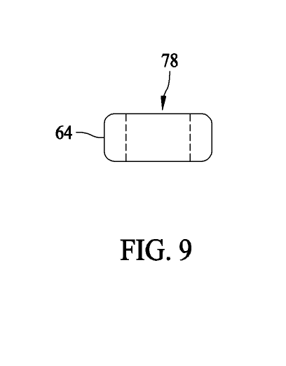

FIG. 7 is a top plan schematic diagram of an exemplary embodiment of shim 64. FIG. 8 is a side plan schematic diagram of an exemplary embodiment of shim 64. FIG. 9 is a front plan schematic diagram of an exemplary embodiment of shim 64.

Shim 64 (as shown in FIGS. 7-9) includes two openings 78, described above in regard to FIG. 2a. However, shim 64 may include any number of openings 78.

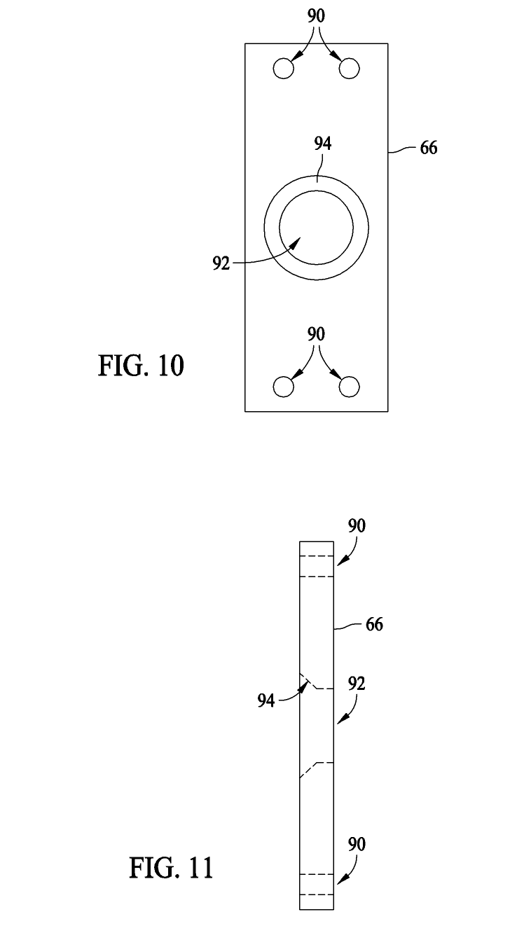

FIG. 10 is a top plan schematic of an exemplary embodiment of guide member 66. FIG. 11 is a side plan schematic of an exemplary embodiment of guide member 66. In the exemplary embodiment of FIGS. 10 and 11, guide member 66 includes two pairs of fastener openings 90. Guide member 66 also includes eduction pipe opening 92 and bevel 94. Each pair of fastener openings 90 are positioned on opposite sides of eduction pipe opening 92 to support guide member 66 on both sides of sump 30. In another exemplary embodiment, guide member 66 includes one fastener opening 90 on each side of eduction pipe opening 92. In other exemplary embodiments, guide member 66 includes any number of fastener openings 90 so long as at least one fastener opening 90 is included on each side of eduction pipe opening 92 and at least one fastener opening 90 is positioned so as to be aligned with at least one tapped opening 72.

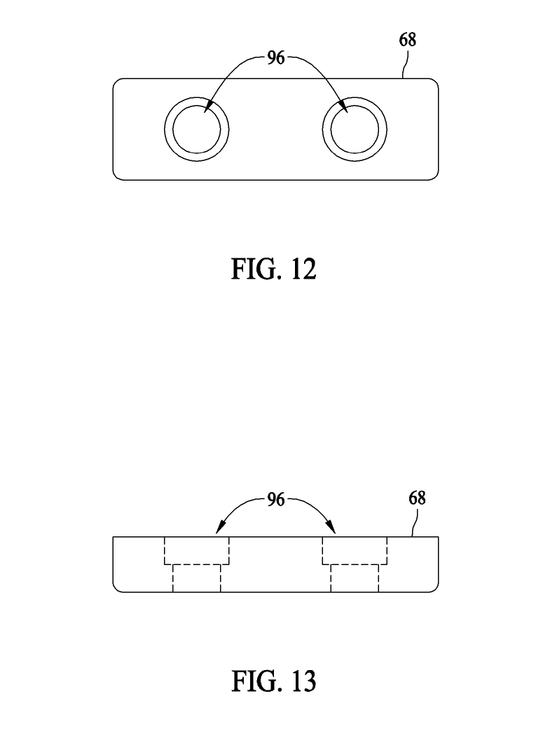

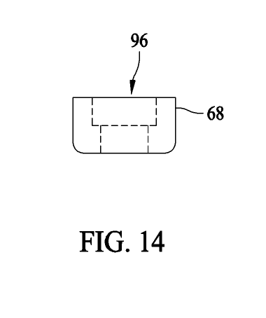

FIG. 12 is a top plan schematic of an exemplary embodiment of countersunk pad 68. FIG. 13 is a side plan schematic of an exemplary embodiment of countersunk pad 68. FIG. 14 is a front plan schematic of an exemplary embodiment of countersunk pad 68.

Countersunk pad 68 (as shown in FIGS. 12-14) includes two countersunk openings 96, which fastener 70 is configured to extend through. However, countersunk pad 68 may include any number of openings 96, so long as at least one opening 96 is positioned so as to be in alignment with at least tapped opening 72 and at least one fastener opening 90. Countersunk opening 96 is countersunk to provide a recessed area to house a portion of fastener 70, for example, a head of a bolt or a capscrew.

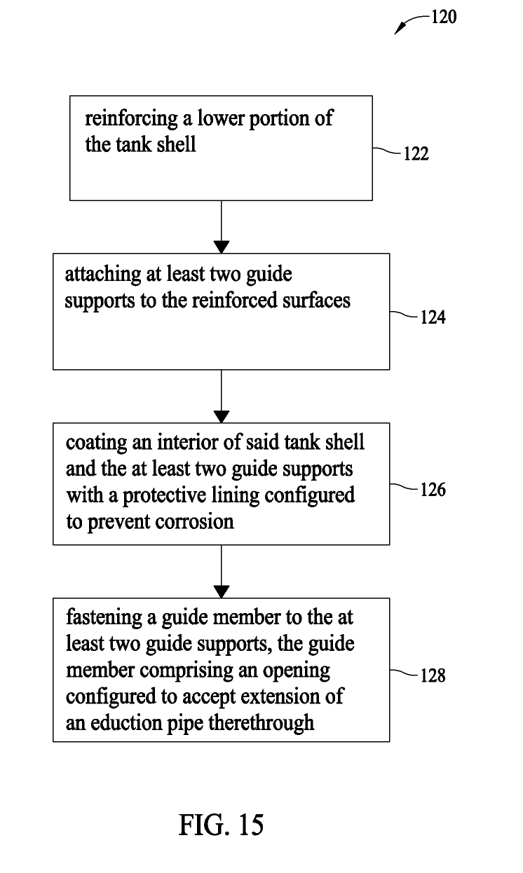

FIG. 15 is a flow chart of a method 120 of assembling eduction pipe guide 14 within a tank car 10. Method 120 includes reinforcing 122 tank shell 16. In an exemplary embodiment, reinforcing 122 includes attaching at least one reinforcement pad 60 to tank shell 16. Method 120 also includes attaching 124 at least one guide support 62 to the reinforced surfaces of tank shell 16. Method 120 also includes coating 126 interior surface 18 of tank shell 16 and guide supports 62 with a protective lining configured to prevent corrosion. Method 120 further includes fastening 128 guide member 66 to at least one guide support 62, the guide member comprising an opening configured to accept extension of an eduction pipe therethrough.

In an exemplary embodiment, reinforcement pad 60 and guide supports 62 are configured to enable coating 126. It is difficult to applying a protective coating to a surface of a component attached to and facing tank shell 16, or to a component attached to tank shell 16 at a connection forming a small angle between tank shell 16 and the component. Since coating 126 occurs prior to fastening 128 a guide member to the guide supports, all exposed surfaces of reinforcement pad 60 and guide supports 62 are can be reached for coating 126. Furthermore, the connections between guide supports 62, reinforcement pad 60, and tank shell 16 only include angles large enough to facilitate application of the protective lining by spraying, painting, adhesively attaching, or any other method of applying a protective lining.

Method 120 may also include positioning (not shown in FIG. 15) at least one shim 64 between the guide supports 62 and the guide member 66. The at least one shim 64 is positioned above the guide supports 62 after coating 126 of guide supports 62. If necessary, the at least one shim 64 is coated with a protective lining before positioning above the coated guide supports 62. By coating 126 the guide supports 62 prior to positioning at least one shim 64, and coating the at least one shim 64 before positioning the at least one shim 64 within tank car 10, sufficient protective lining of the components is possible.

Fastening 128 guide member 66 to at least one guide support 62 may further include configuring (not shown in FIG. 15) at least one opening within the guide member, the guide supports, and in certain embodiments, the at least one shim, which when aligned, accept and secure a fastener therethrough.

In use, eduction pipe guide 14 maintains eduction pipe 12 at a predetermined position within tank car 10, which prevents a bottom edge of eduction pipe 12, which is typically made of a material that is harder than protective lining 40 covering tank shell 16, from contacting and potentially damaging protective lining 40 of tank shell 16. Eduction pipe guide 14 is also configured to enable sufficient coating of the components of eduction pipe guide 14 and tank shell 16 to prevent corrosion of the components of eduction pipe guide 14 and tank shell 16.

While the invention has been described in terms of various specific embodiments, those skilled in the art will recognize that the invention can be practiced with modification within the spirit and scope of the claims.

What is claimed is:

1. A railway tank car comprising:
a tank comprising a tank shell, said tank shell having an interior surface and an exterior surface;
an eduction pipe extending within an interior of said tank; and
an eduction pipe guide affixed to said tank shell, said eduction pipe guide comprising a guide member maintained at a predetermined distance from a lower portion of said tank shell interior surface, said eduction pipe guide configured such that at least a portion of said eduction pipe extends through said guide member.

2. A railway tank car according to claim 1 wherein said guide member comprises a non-corrosive material configured to withstand corrosion without a protective lining.

3. A railway tank car according to claim 1 wherein said tank shell lower portion comprises a sump, said sump providing a reservoir within the railway tank car.

4. A railway tank car according to claim 3 wherein said eduction pipe extends into said sump.

5. A railway tank car according to claim 3 wherein said eduction pipe guide positions said eduction pipe over at least a portion of said sump.

6. A railway tank car according to claim 1 wherein said eduction pipe guide comprises at least two guide supports, said guide member engaged to said at least two guide supports at a predetermined distance from said lower portion of said tank shell interior surface.

7. A railway tank car according to claim 1 wherein said eduction pipe guide comprises at least one fastener configured to secure said guide member to said at least two guide supports.

8. A railway tank car according to claim 7 wherein said at least one fastener comprises a threaded bolt.

9. An eduction pipe guide for use in a railway tank car, said railway tank car comprising a tank shell, said tank shell having an interior surface and an exterior surface, said eduction pipe guide comprising:
at least two guide supports configured to attach to and extend from said tank shell; and
a guide member configured to extend between said at least two guide supports, said guide member comprising an opening configured so that at least a portion of an eduction pipe can extend therethrough.

10. An eduction pipe guide according to claim 9 wherein said guide member comprises a non-corrosive material configured to withstand corrosion without a protective lining.

11. An eduction pipe guide according to claim 9 further comprising at least one fastener, which in combination with said at least two guide supports, is configured to maintain said guide member a predetermined distance from a lower portion of said tank shell interior surface.

12. An eduction pipe guide according to claim 9 further comprising at least one reinforcement pad attached to said tank shell, said at least one reinforcement pad configured to reinforce said tank shell at the positions of said at least two guide supports.

13. An eduction pipe guide according to claim 9 further comprising at least one shim positioned between said at least two guide supports and said guide member, said at least one shim configured to establish the distance said guide member is positioned from said tank shell.

14. An eduction pipe guide according to claim 9 wherein the railway tank car further comprises a sump, said sump configured to provide a reservoir within the railway tank car.

15. An eduction pipe guide according to claim 9 wherein said opening within said guide member is configured to be positioned at least partially above said sump.

16. A method of assembling an eduction pipe guide within a railway tank car, the railway tank car including a tank shell, said method comprising:
reinforcing a lower portion of the tank shell;
attaching at least two guide supports to the reinforced surfaces;
coating an interior of the tank shell and the at least two guide supports with a protective lining configured to prevent corrosion; and
fastening a guide member to the at least two guide supports, the guide member comprising an opening configured so that at least a portion of an eduction pipe can extend therethrough.

17. A method according to claim 16 wherein attaching at least two guide supports comprises attaching the guide supports such that coating the guide supports is possible.

18. A method according to claim 16 wherein reinforcing an interior surface comprises attaching a reinforcement pad to the tank shell.

19. A method according to claim 16 wherein coating an interior comprises at least one of spraying, rolling, brushing, and adhesively attaching a protective lining to at least the tank shell and the at least two guide supports.

20. A method according to claim 16 further comprising positioning at least one shim between the at least two guide supports and the guide member.

21. A method according to claim 16 wherein fastening a guide member further comprises sealing a fastener using at least one countersunk pad and coating the at least one countersunk pad after installation.

22. A method for securing an eduction pipe within a railway tank car, the railway tank car including a tank shell and a sump at a lower portion of the shell, said method comprising:
providing an eduction pipe guide comprising an opening;
affixing the eduction pipe guide to the tank shell such that the opening within the eduction pipe guide is positioned a distance from, and at least partially aligned with, the sump of the railway tank car; and
inserting at least a portion of the eduction pipe through the opening.

23. A method according to claim 22 wherein affixing the eduction pipe guide to the tank shell further comprises affixing at least two guide supports to the tank shell and configuring the at least two guide supports to receive and secure at least one fastening device.

24. A method according to claim 22 wherein affixing the eduction pipe guide to the tank shell further comprises positioning at least one shim on the at least two guide supports.

25. A method according to claim 22 wherein affixing the eduction pipe guide to the tank shell further comprises reinforcing the tank shell where the eduction pipe guide is affixed to the tank shell.
